(19) United States
(12) Patent Application Publication
(10) Pub. No.: US 2026/0357949 A1
(43) Pub. Date: Nov. 12, 2026

(54) RECONDENSING DEVICE

(71) Applicant: SUMITOMO HEAVY INDUSTRIES, LTD., Tokyo (JP)

(72) Inventor: Takashi HIRAYAMA, Yokosuka-shi (JP)

(73) Assignee: SUMITOMO HEAVY INDUSTRIES, LTD., Tokyo (JP)

(21) Appl. No.: 19/713,821

(22) Filed: Jun. 19, 2026

Related U.S. Application Data
(63) Continuation of application No. PCT/JP2025/003781, filed on Feb. 5, 2025.

(30) Foreign Application Priority Data
Mar. 21, 2024 (JP) 2024-045497

(51) Int. Cl. F17C 1/12

(52) U.S. Cl. CPC F17C 1/12; F17C 2203/0391; F17C 2223/0161; F17C 2227/0353; F17C 2265/034

(57) ABSTRACT

A recondensing device includes a vacuum container, a cryogenic liquid tank that is disposed in the vacuum container, a neck tube that connects the vacuum container and the cryogenic liquid tank, and a two-stage cryocooler that is inserted into the neck tube and installed in the vacuum container. A second cylinder of the cryocooler includes an axial intermediate portion cooled to an intermediate cooling temperature lower than a first cooling temperature of a first cooling stage and higher than a second cooling temperature of a second cooling stage. The recondensing device includes a tubular support body that supports the cryogenic liquid tank on the vacuum container, and a heat bridge that connects the tubular support body to the neck tube at an axial position of the axial intermediate portion of the second cylinder.

### CROSS-REFERENCE TO RELATED APPLICATIONS

This is a bypass continuation of International PCT Application No. PCT/JP2025/003781, filed on Feb. 5, 2025, which claims priority to Japanese Patent Application No. 2024-045497, filed on Mar. 21, 2024, which are incorporated by reference herein in their entirety.

### BACKGROUND

### Technical Field

A certain embodiment of the present invention relates to a recondensing device.

### Description of Related Art

The related art discloses a recondensing device for cryogenic liquid such as liquid helium, equipped with a cryocooler. Gas vaporized from the cryogenic liquid is cooled by the cryocooler and recondensed. The recondensed cryogenic liquid is stored in a cryogenic liquid tank. The cryogenic liquid can be used for cooling various cooling targets such as superconducting equipment. The cryogenic liquid tank is housed in a vacuum container for thermal insulation from the surrounding environment.

### SUMMARY

One or more embodiments provide a recondensing device including: a vacuum container; a cryogenic liquid tank that is disposed in the vacuum container; a neck tube that connects the vacuum container and the cryogenic liquid tank; and a two-stage cryocooler that is inserted into the neck tube and installed in the vacuum container. The two-stage cryocooler includes a first cylinder and a second cylinder that are provided in series in an axial direction, a first cooling stage that is provided at an end of the first cylinder and cooled to a first cooling temperature, and a second cooling stage that is provided at an end of the second cylinder and cooled to a second cooling temperature lower than the first cooling temperature. The second cylinder includes an axial intermediate portion cooled to an intermediate cooling temperature lower than the first cooling temperature and higher than the second cooling temperature. The recondensing device includes a tubular support body that supports the cryogenic liquid tank on the vacuum container, and a heat bridge that connects the tubular support body to the neck tube at an axial position of the axial intermediate portion of the second cylinder.

### BRIEF DESCRIPTION OF THE DRAWINGS

FIG. 1 is a diagram schematically illustrating a recondensing device according to an embodiment;

FIG. 2 is a diagram schematically illustrating a cryocooler that is applicable to the recondensing device illustrated in FIG. 1;

FIG. 3 is a graph illustrating a preferred cooling temperature of a heat bridge, according to the embodiment;

FIG. 4 is a graph illustrating a preferred cooling temperature of a heat bridge, according to the embodiment;

FIG. 5 is a graph illustrating a preferred cooling temperature of a heat bridge, according to the embodiment; and

FIG. 6 is a graph illustrating a preferred cooling temperature of a heat bridge, according to the embodiment.

### DETAILED DESCRIPTION

The above recondensing device has been studied, and the following has been recognized. The cryogenic liquid tank requires some physical connection to the vacuum container for various uses, such as supporting the cryogenic liquid tank in the vacuum container, supplying gas or liquid to the cryogenic liquid tank or discharging gas or liquid from the cryogenic liquid tank, or connecting to external equipment such as measurement equipment. Some heat may enter the cryogenic liquid tank from the outside through such a connection structure as a heat transfer path.

It is desirable to provide a recondensing device in which heat ingress into the cryogenic liquid tank is reduced.

According to the embodiment of the present invention, it is possible to reduce heat ingress into the cryogenic liquid tank of the recondensing device.

Hereinafter, an embodiment for carrying out the present invention will be described in detail with reference to the accompanying drawings. In the description and the drawings, the same or equivalent components, members, and processes are denoted by the same reference signs, and duplicate description will be omitted as appropriate. The scale and shape of each illustrated portion are set for convenience to facilitate description and are not to be interpreted as limiting unless otherwise specified. The embodiment is illustrative and does not limit the scope of the present invention in any way. All features and combinations thereof described in the embodiment are not necessarily essential to the invention.

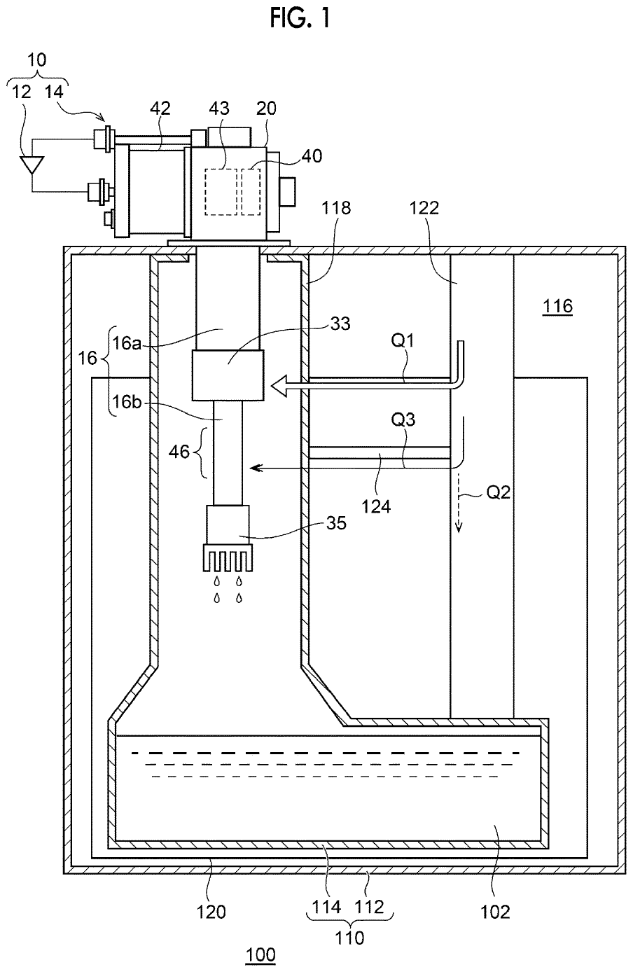

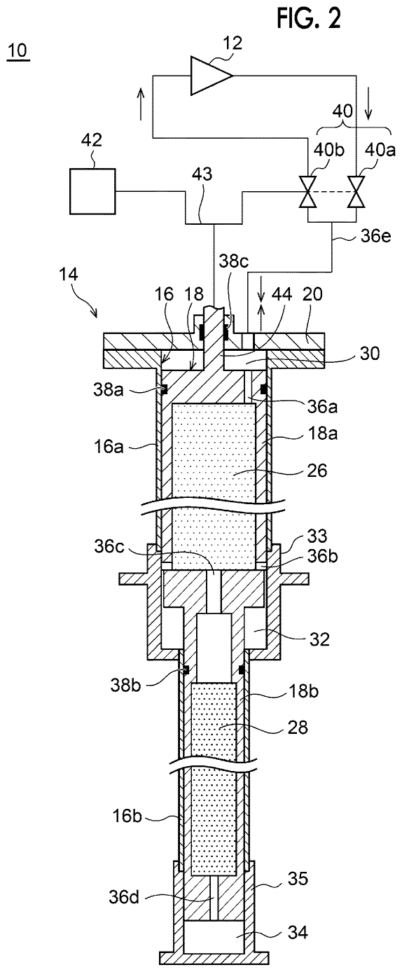

FIG. 1 is a diagram schematically illustrating a recondensing device 100 according to the embodiment. FIG. 2 is a diagram schematically illustrating a cryocooler 10 that is applicable to the recondensing device 100 illustrated in FIG. 1.

The recondensing device 100 includes a vacuum container 110 for storing, for example, liquid helium or another cryogenic liquid 102. The cryocooler 10 cools the stored cryogenic liquid 102 to a cryogenic temperature that is equal to or lower than a liquefaction temperature thereof (in a case of liquid helium, about 4 K). The vaporized cryogenic liquid 102 is cooled and recondensed by the cryocooler 10. The recondensing device 100 may be a part of, for example, a magnetic resonance imaging (MRI) system or a superconducting system having superconducting equipment such as a superconducting electromagnet. The cryogenic liquid 102 may be used to cool an object to be cooled, such as a superconducting coil, to a cryogenic temperature that is equal to or lower than a critical temperature. Alternatively, the recondensing device 100 may be a part of another cryogenic system.

The vacuum container 110 includes an outer vessel 112, a cryogenic liquid tank 114 that is disposed in the outer vessel 112, and a neck tube 118 that connects the outer vessel 112 and the cryogenic liquid tank 114 of the vacuum container 110. A vacuum insulation layer 116 is formed between the outer vessel 112 and the cryogenic liquid tank 114, and the outer vessel 112 is configured to separate the vacuum insulation layer 116 from the surrounding environment (for example, the room-temperature atmospheric-pressure environment) of the recondensing device 100. For example, a heat insulation structure, such as multilayer insulation (MLI), may be provided in the vacuum insulation layer 116. In addition, the cryogenic liquid tank 114 is configured to house the cryogenic liquid 102 therein and to separate the cryogenic liquid 102 from the vacuum insulation layer 116. The neck tube 118 forms a part of the cryogenic liquid tank 114, and an internal volume of the neck tube 118 can be filled with the vaporized cryogenic liquid 102.

The outer vessel 112, the cryogenic liquid tank 114, and the neck tube 118 are formed of, for example, a metal material such as stainless steel or another suitable high-strength material so as to withstand a pressure difference between the inside and the outside. In order to reduce heat ingress into the cryogenic liquid tank 114 from the outer vessel 112 through the neck tube 118, the neck tube 118 may be formed of a thermal insulation material. Here, the thermal insulation material may be, for example, a material having a thermal conductivity of, for example, 1/10 or less of a thermal conductivity of a high thermal conductivity material such as copper. The neck tube 118 may be formed of, for example, stainless steel, glass fiber reinforced plastic (GFRP) or other plastic material, or other suitable thermal insulation material.

The external appearance of the cryocooler 10 is illustrated in FIG. 1, and the internal structure of the cryocooler 10 is illustrated in FIG. 2. The cryocooler 10 is, for example, a two-stage Gifford-McMahon (GM) cryocooler. As illustrated in FIG. 1, the cryocooler 10 is inserted into the neck tube 118 and installed in the vacuum container 110.

The cryocooler 10 includes a compressor 12 and an expander 14. The compressor 12 is configured to recover working gas of the cryocooler 10 from the expander 14, pressurize the collected working gas, and supply the working gas to the expander 14 again. The working gas is also referred to as refrigerant gas and is typically helium gas, but another suitable gas may be used.

The expander 14 includes a cryocooler cylinder 16, a displacer assembly 18, and a cryocooler housing 20. The cryocooler housing 20 is coupled to the cryocooler cylinder 16 to form a hermetic container that houses the displacer assembly 18. The cryocooler cylinder 16 and the cryocooler housing 20 are formed of, for example, a metal material such as stainless steel or other suitable high-strength materials.

The expander 14 is installed in an outer vessel 112 of the vacuum container 110 in a state where the cryocooler cylinder 16 is inserted into the neck tube 118 of the vacuum container 110 and the cryocooler housing 20 is attached to the outside of the vacuum container 110. As an example, the expander 14 is installed at an upper portion of the vacuum container 110 such that a center axis thereof coincides with a vertical direction. However, the mounting location and the mounting posture of the expander 14 are not limited thereto. For example, the expander 14 may be installed at a lower portion of the vacuum container 110. Further, the expander 14 can be installed in a desired posture, and may be installed in the vacuum container 110 such that the center axis coincides with an oblique direction or a horizontal direction.

The cryocooler cylinder 16 includes a first cylinder 16a and a second cylinder 16b that extend in an axial direction (up-down direction in FIGS. 1 and 2). The second cylinder 16b is provided in series with the first cylinder 16a in the axial direction. As an example, each of the first cylinder 16a and the second cylinder 16b is a member having a cylindrical shape, and the second cylinder 16b has a smaller diameter than the first cylinder 16a. The first cylinder 16a and the second cylinder 16b are coaxially disposed, and a lower end of the first cylinder 16a is rigidly connected to an upper end of the second cylinder 16b.

The displacer assembly 18 includes a first displacer 18a and a second displacer 18b. As an example, each of the first displacer 18a and the second displacer 18b is a member having a cylindrical shape, and the second displacer 18b has a smaller diameter than the first displacer 18a. The first displacer 18a and the second displacer 18b are coaxially disposed.

The first displacer 18a is housed in the first cylinder 16a, and the second displacer 18b is housed in the second cylinder 16b. The first displacer 18a can reciprocate in the axial direction along the first cylinder 16a, and the second displacer 18b can reciprocate in the axial direction along the second cylinder 16b. The first displacer 18a and the second displacer 18b are connected to each other, and move integrally with each other.

In the present specification, for convenience in describing positional relationships between components of the cryocooler 10, a side close to a top dead center of the axial reciprocation of the displacer will be referred to as “up” and a side close to a bottom dead center will be referred to as “down”. The top dead center is a position of the displacer at which a volume of an expansion space is the maximum, and the bottom dead center is a position of the displacer at which the volume of the expansion space is the minimum. During operation of the cryocooler 10, a temperature gradient occurs in which the temperature decreases from an upper side toward a lower side in the axial direction, and thus the upper side may also be referred to as a high-temperature side and the lower side may also be referred to as a low-temperature side.

The first displacer 18a houses a first regenerator 26. The first regenerator 26 is formed by filling a tubular body portion of the first displacer 18a with a wire mesh made of, for example, copper or another suitable first regenerator material. An upper lid portion and a lower lid portion of the first displacer 18a may be provided as members separate from the body portion of the first displacer 18a, and the upper lid portion and the lower lid portion of the first displacer 18a may be fixed to the body portion by suitable means such as fastening or welding, so that the first regenerator material may be housed in the first displacer 18a.

Similarly, the second displacer 18b houses a second regenerator 28. The second regenerator 28 is formed by filling a tubular body portion of the second displacer 18b with a nonmagnetic regenerator material such as, for example, bismuth, a magnetic regenerator material such as HoCu₂, or another suitable second regenerator material. The second regenerator material may be in particulate form. An upper lid portion and a lower lid portion of the second displacer 18b may be provided as members separate from the body portion of the second displacer 18b, and the upper lid portion and the lower lid portion of the second displacer 18b may be fixed to the body portion by suitable means such as fastening or welding, so that the second regenerator material may be housed in the second displacer 18b.

The displacer assembly 18 forms an upper chamber 30, a first expansion chamber 32, and a second expansion chamber 34 inside the cryocooler cylinder 16. For heat exchange with a desired object or medium to be cooled by the cryocooler 10, the expander 14 includes a first cooling stage 33 and a second cooling stage 35. The upper chamber 30 is formed between the upper lid portion of the first displacer 18a and an upper portion of the first cylinder 16a. The first expansion chamber 32 is formed between the lower lid portion of the first displacer 18a and the first cooling stage 33. The second expansion chamber 34 is formed between the lower lid portion of the second displacer 18b and the second cooling stage 35. The first cooling stage 33 is fixed to a lower portion of the first cylinder 16a so as to surround the first expansion chamber 32, and the second cooling stage 35 is fixed to a lower portion of the second cylinder 16b so as to surround the second expansion chamber 34. The first cooling stage 33 and the second cooling stage 35 are formed of, for example, pure copper (for example, oxygen-free copper, tough pitch copper, or the like) or another high-thermal-conductivity metal.

The first regenerator 26 is connected to the upper chamber 30 through a working gas flow path 36a formed in the upper lid portion of the first displacer 18a, and is connected to the first expansion chamber 32 through a working gas flow path 36b formed in the lower lid portion of the first displacer 18a. The second regenerator 28 is connected to the first regenerator 26 through a working gas flow path 36c formed from the lower lid portion of the first displacer 18a to the upper lid portion of the second displacer 18b. The second regenerator 28 is also connected to the second expansion chamber 34 through a working gas flow path 36d formed in the lower lid portion of the second displacer 18b.

A first seal 38a and a second seal 38b may be provided so that working gas flow between the first expansion chamber 32 and the upper chamber 30 and between the second expansion chamber 34 and the upper chamber 30 is guided to the first regenerator 26 and the second regenerator 28, rather than to a clearance between the cryocooler cylinder 16 and the displacer assembly 18. The first seal 38a may be mounted on the upper lid portion of the first displacer 18a so as to be disposed between the first displacer 18a and the first cylinder 16a. The second seal 38b may be mounted on the upper lid portion of the second displacer 18b so as to be disposed between the second displacer 18b and the second cylinder 16b.

In addition, the expander 14 includes a pressure switching valve 40 and a drive motor 42. The pressure switching valve 40 is housed in the cryocooler housing 20, and the drive motor 42 is attached to the cryocooler housing 20.

As illustrated in FIG. 2, the pressure switching valve 40 includes a high-pressure valve 40a and a low-pressure valve 40b, and is configured to generate periodic pressure variations in the cryocooler cylinder 16. A working gas discharge port of the compressor 12 is connected to the upper chamber 30 via the high-pressure valve 40a, and a working gas suction port of the compressor 12 is connected to the upper chamber 30 via the low-pressure valve 40b. The high-pressure valve 40a and the low-pressure valve 40b are configured to open and close selectively and alternately, that is, such that when one is open, the other is closed. A high-pressure (for example, 2 to 3 MPa) working gas is supplied from the compressor 12 to the expander 14 through the high-pressure valve 40a, and a low-pressure (for example, 0.5 to 1.5 MPa) working gas is recovered from the expander 14 to the compressor 12 through the low-pressure valve 40b. For ease of understanding, directions in which the working gas flows are indicated by arrows in FIG. 2.

The drive motor 42 is provided to drive reciprocation of the displacer assembly 18. The drive motor 42 is coupled to a displacer drive shaft 44 via a motion conversion mechanism 43 such as, for example, a Scotch yoke mechanism. The motion conversion mechanism 43 is housed in the cryocooler housing 20 as with the pressure switching valve 40. The displacer drive shaft 44 extends from the motion conversion mechanism 43 through the cryocooler housing 20 into the upper chamber 30, and is fixed to the upper lid portion of the first displacer 18a. A third seal 38c is provided to prevent leakage of the working gas from the upper chamber 30 to the cryocooler housing 20, which may be maintained at a low pressure as described above. The third seal 38c may be mounted on the cryocooler housing 20 so as to be disposed between the cryocooler housing 20 and the displacer drive shaft 44.

When the drive motor 42 is driven, rotational output of the drive motor 42 is converted by the motion conversion mechanism 43 into axial reciprocation of the displacer drive shaft 44, and the displacer assembly 18 reciprocates in the axial direction within the cryocooler cylinder 16. The drive motor 42 is also coupled to the high-pressure valve 40a and the low-pressure valve 40b so as to selectively and alternately open and close these valves.

When the compressor 12 and the drive motor 42 are operated, the cryocooler 10 generates periodic volume variations in the first expansion chamber 32 and the second expansion chamber 34 and pressure variations of the working gas synchronized with the periodic volume variations, so that a refrigeration cycle is formed and the first cooling stage 33 and the second cooling stage 35 are cooled to desired cryogenic temperatures. The first cooling stage 33 can be cooled to a first cooling temperature within a range of, for example, about 20 K to about 40 K. The second cooling stage 35 can be cooled to a second cooling temperature (for example, about 1 K to about 4 K) lower than the first cooling temperature.

As described above, the cryocooler 10 is disposed in the neck tube 118 filled with the vaporized cryogenic liquid 102 (for example, helium gas). Due to convective heat transfer via gas of the cryogenic liquid 102 between the cryocooler 10 and the neck tube 118, the neck tube 118 has an axial temperature distribution similar to that of the cryocooler 10. Therefore, the neck tube 118 has the first cooling temperature at the same axial height as the first cooling stage 33, and has the second cooling temperature at the same axial height as the second cooling stage 35.

In order to thermally protect the cryogenic liquid tank 114 of the vacuum container 110, the second cooling stage 35 of the cryocooler 10, and other low-temperature sections, the vacuum container 110 may be provided with a radiation shield 120 disposed in the vacuum insulation layer 116 so as to surround these low-temperature sections. The radiation shield 120 is connected to the neck tube 118 at the same axial height as the first cooling stage 33 of the cryocooler 10, is thermally coupled to the first cooling stage 33 via gas in the neck tube 118, and is cooled to the first cooling temperature. The radiation shield 120 is formed of a metal material such as, for example, copper or another material having high thermal conductivity.

The vacuum container 110 includes a tubular support body 122 that supports the cryogenic liquid tank 114 on the outer vessel 112 of the vacuum container 110. Therefore, the tubular support body 122 has one end connected to the outer vessel 112, and the other end connected to the cryogenic liquid tank 114. As an example, one end of the tubular support body 122 is connected to an upper wall of the outer vessel 112, and the tubular support body 122 extends axially in parallel with the neck tube 118 and supports the cryogenic liquid tank 114 from above. However, the mounting location and mounting posture of the tubular support body 122 are not limited thereto. For example, one end of the tubular support body 122 may be connected to a side wall of the outer vessel 112, and the tubular support body 122 may extend in a direction perpendicular to the neck tube 118 or in an oblique direction and support the cryogenic liquid tank 114 from a side. Alternatively, one end of the tubular support body 122 may be connected to a lower wall of the outer vessel 112, and the tubular support body 122 may extend axially in parallel with the neck tube 118 and support the cryogenic liquid tank 114 from below.

The tubular support body 122 may be hollow or solid. When the tubular support body 122 is hollow, an internal volume of the tubular support body 122 may be separated from the cryogenic liquid tank 114 so that vaporized cryogenic liquid 102 does not flow into the tubular support body 122. The internal volume of the tubular support body 122 may be in communication with the vacuum insulation layer 116.

The tubular support body 122 may connect the cryogenic liquid tank 114 to the outer vessel 112 of the vacuum container 110 in order to supply gas or liquid to the cryogenic liquid tank 114 or discharge gas or liquid from the cryogenic liquid tank 114. Alternatively, the tubular support body 122 may provide a passage for extracting wiring of measurement equipment disposed in the cryogenic liquid tank 114 to the outside of the vacuum container 110. In such a case, the tubular support body 122 may form a part of the cryogenic liquid tank 114, similarly to the neck tube 118, and vaporized cryogenic liquid 102 may flow into the tubular support body 122.

In order to reduce heat ingress into the cryogenic liquid tank 114 from the outer vessel 112 of the vacuum container 110 through the tubular support body 122, the tubular support body 122 may be connected to the radiation shield 120 at an axial intermediate portion thereof, as illustrated in FIG. 1. As a result, the radiation shield 120 can be used as a heat transfer path, and a part of heat ingress into the cryogenic liquid tank 114 from the outer vessel 112 through the tubular support body 122 (schematically illustrated as heat ingress Q1 in FIG. 1) can be absorbed by the first cooling stage 33.

In order to reduce heat ingress, the tubular support body 122 may be formed of a material having lower thermal conductivity than a heat transfer member such as the radiation shield 120, for example, a thermal insulation material. Here, the thermal insulation material may be a material having a thermal conductivity of, for example, 1/10 or less of the thermal conductivity of a high thermal conductivity material, such as copper, forming the heat transfer member. The tubular support body 122 may be formed of, for example, stainless steel, glass fiber reinforced plastic (GFRP) or another plastic material, or another suitable thermal insulation material.

In addition to the first cooling stage 33 and the second cooling stage 35, it is known that the expander 14 can absorb heat on the cryocooler cylinder 16, for example, also at an axial intermediate portion of the second cylinder 16b. Such a heat absorbing portion 46 is cooled to a cooling temperature based on an axial temperature distribution on the cryocooler cylinder 16, for example, the second cylinder 16b, and an axial position of the heat absorbing portion 46, and can provide some cooling capacity at this cooling temperature. The heat absorbing portion 46 has an intermediate cooling temperature between the first cooling temperature of the first cooling stage 33 and the second cooling temperature of the second cooling stage 35. The heat absorbing portion 46 may be located, for example, in a range of ¼ to ¾ at a normalized axial position on the second cylinder 16b, that is, a dimensionless axial position at which the positions of the first cooling stage 33 and the second cooling stage 35 are set to 0 and 1, respectively.

In a typical use case of the cryocooler 10, an object to be cooled is thermally connected to either the first cooling stage 33 or the second cooling stage 35 according to a desired cooling temperature and is cooled. Nothing is connected to the heat absorbing portion 46 on the second cylinder 16b, and the cooling capacity of the heat absorbing portion 46 is not used. However, using the cooling capacity of the heat absorbing portion 46 in addition to the two cooling stages may lead to more efficient cooling of the recondensing device 100.

Therefore, the vacuum container 110 of the recondensing device 100 may be provided with a heat bridge 124. The heat bridge 124 connects the tubular support body 122 to the neck tube 118 at the axial position of the axial intermediate portion (that is, the heat absorbing portion 46) of the second cylinder 16b. The heat bridge 124 is formed of a metal material such as, for example, copper or another material having high thermal conductivity. As described above, due to convective heat transfer between the cryocooler 10 and the neck tube 118 via gas of the cryogenic liquid 102, the neck tube 118 has an axial temperature distribution similar to that of the cryocooler 10, and therefore has the intermediate cooling temperature at the same axial height as the heat absorbing portion 46. Therefore, the heat bridge 124 is thermally coupled to the heat absorbing portion 46 via gas in the neck tube 118 and is cooled to the intermediate cooling temperature.

A temperature difference corresponding to a temperature difference between the first cooling temperature and the second cooling temperature of the cryocooler 10 occurs between a connection part of the tubular support body 122 to the radiation shield 120 and a low-temperature end of the tubular support body 122 connected to the cryogenic liquid tank 114. The heat bridge 124 can be used as an additional heat transfer path in order to reduce heat ingress into the cryogenic liquid tank 114 corresponding to such a temperature difference along the tubular support body 122 (schematically illustrated as heat ingress Q2 in FIG. 1). A part of the heat ingress from the tubular support body 122 through the heat bridge 124 to the heat absorbing portion 46 (schematically illustrated as heat ingress Q3 in FIG. 1) can be absorbed.

As described above, according to the embodiment, the tubular support body 122 can be cooled using not only the first cooling stage 33 and the second cooling stage 35 but also the cooling capacity of the heat absorbing portion 46 on the second cylinder 16b. Compared with a typical cooling configuration that does not use the heat absorbing portion 46, the recondensing device 100 can be cooled more efficiently, and heat ingress Q2 into the cryogenic liquid tank 114 can be reduced.

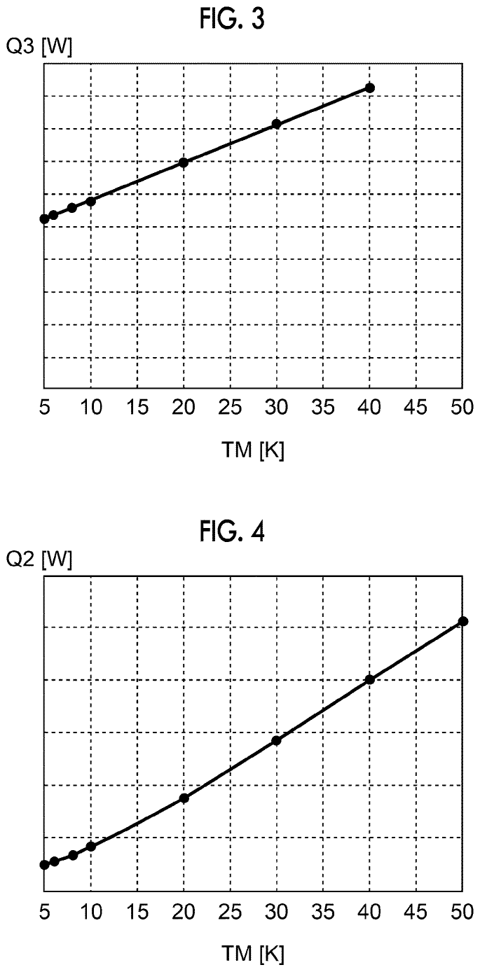

Next, with reference to FIGS. 3 to 6, a preferred cooling temperature of the heat bridge 124 will be described. As described below, the intermediate cooling temperature to which the heat bridge 124 is cooled is preferably in a temperature range of 7 K or more and 20 K or less.

FIG. 3 is a graph illustrating how heat ingress Q3 flowing to the heat absorbing portion 46 via the heat bridge 124 changes depending on the cooling temperature TM of the heat bridge 124. FIG. 4 is a graph illustrating how the heat ingress Q2 flowing from the connection part of the tubular support body 122 to the heat bridge 124 to the cryogenic liquid tank 114 changes depending on the cooling temperature TM of the heat bridge 124.

As can be understood from FIG. 3, the heat ingress Q3 via the heat bridge 124 decreases as the cooling temperature TM of the heat bridge 124 decreases. Further, as can be understood from FIG. 4, the heat ingress Q2 into the cryogenic liquid tank 114 without passing through the heat bridge 124 also decreases as the cooling temperature TM of the heat bridge 124 decreases.

FIGS. 3 and 4 illustrate calculation results obtained by the inventor when the first cooling temperature and the second cooling temperature of the cryocooler 10 are assumed to be 50 K and 4 K, respectively. However, calculations by the inventor have confirmed that the tendency for heat ingress Q2 and Q3 to decrease as the cooling temperature TM of the heat bridge 124 decreases is common even when the first cooling temperature and the second cooling temperature of the cryocooler 10 are different.

Therefore, in order to reduce the heat ingress Q2 into the cryogenic liquid tank 114, it can be said that the cooling temperature TM of the heat bridge 124 is preferably made as low as possible, that is, brought closer to the second cooling temperature. This means that the heat bridge 124 should be installed as close as possible to the second cooling stage 35 of the cryocooler 10 in the axial direction of the neck tube 118 and the tubular support body 122.

However, when the axial position of the heat bridge 124 is close to the second cooling stage 35 of the cryocooler 10, the temperature of the second cooling stage 35 may be affected depending on the magnitude of the heat ingress Q3 via the heat bridge 124, that is, the second cooling temperature may increase. This is undesirable because an increase in the second cooling temperature leads to an increase in the temperature of the cryogenic liquid tank 114.

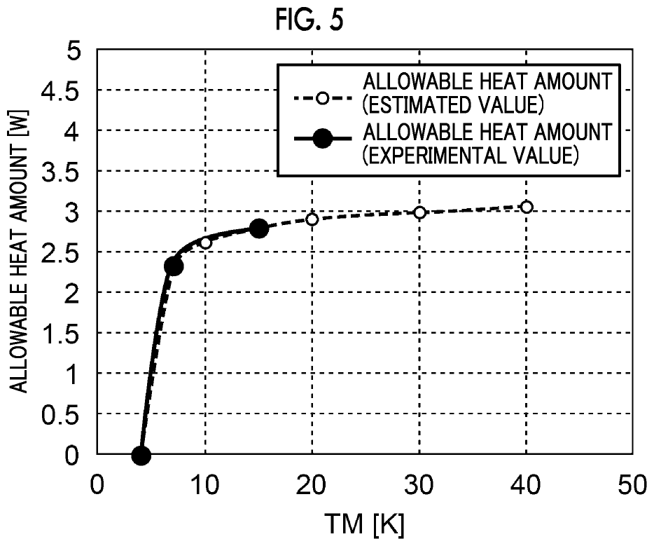

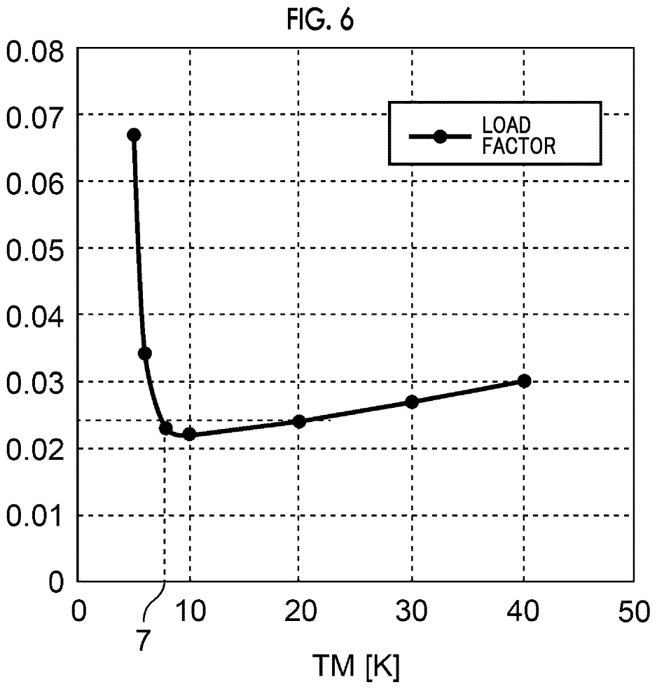

Here, the inventor has found that the second cooling temperature of the cryocooler 10 can be maintained as long as the heat ingress Q3 through the heat bridge 124 does not exceed an allowable heat amount. In other words, when the heat ingress Q3 via the heat bridge 124 is smaller than this allowable heat amount, the heat ingress Q3 is absorbed by the heat absorbing portion 46, and the second cooling temperature of the cryocooler 10 does not increase. The allowable heat amount changes depending on the cooling temperature TM of the heat bridge 124. FIG. 5 is a graph illustrating how the allowable heat amount of the heat ingress Q3 via the heat bridge 124 changes depending on the cooling temperature TM of the heat bridge 124. FIG. 5 illustrates calculation results and experimental results of the allowable heat amount.

Therefore, a ratio of the heat ingress Q3 to the allowable heat amount (=Q3/allowable heat amount) is defined as a load factor. FIG. 6 is a graph illustrating changes in this load factor depending on the cooling temperature TM of the heat bridge 124. In order to maintain the second cooling temperature, the load factor is preferably as small as possible. It can be seen from FIG. 6 that the load factor takes a minimum value (about 0.022) when the cooling temperature TM of the heat bridge 124 is 10 K.

When the cooling temperature TM of the heat bridge 124 is in a temperature range of 7 K or more and 20 K or less, the load factor can be kept to a small value of about 0.024 or less. Therefore, the cooling temperature TM of the heat bridge 124, that is, the intermediate cooling temperature at the heat absorbing portion 46, is preferably in a temperature range of 7 K or more and 20 K or less.

The present invention has been described above based on the embodiment. It is understood by those skilled in the art that the present invention is not limited to the above embodiments, that various design changes and modifications are possible, and that such modifications are also within the scope of the present invention. Various features described in relation to a certain embodiment are also applicable to other embodiments. A new embodiment resulting from such a combination has the effects of each of the combined embodiments.

In the above embodiment, the cryocooler 10 is described as an example of a two-stage GM cryocooler, but other configurations are also possible. For example, the cryocooler 10 may be another type of two-stage cryocooler, such as a Solvay cryocooler, a Stirling cryocooler, or a pulse tube cryocooler.

Although the present invention has been described using specific terms based on the embodiment, the embodiment merely illustrates one aspect of the principles and applications of the present invention, and many modifications and changes in arrangement may be made to the embodiment without departing from the scope of the present invention defined in the claims.

The present invention can be used in the field of recondensing devices.

It should be understood that the invention is not limited to the above-described embodiment, but may be modified into various forms on the basis of the spirit of the disclosure. Additionally, the modifications are included in the scope of the disclosure.

What is claimed is:

1. A recondensing device comprising:
a vacuum container;
a cryogenic liquid tank that is disposed in the vacuum container;
a neck tube that connects the vacuum container and the cryogenic liquid tank;
a two-stage cryocooler that is inserted into the neck tube and installed in the vacuum container, the two-stage cryocooler including a first cylinder and a second cylinder that are provided in series in an axial direction, a first cooling stage that is provided at an end of the first cylinder and cooled to a first cooling temperature, and a second cooling stage that is provided at an end of the second cylinder and cooled to a second cooling temperature lower than the first cooling temperature, the second cylinder including an axial intermediate portion cooled to an intermediate cooling temperature lower than the first cooling temperature and higher than the second cooling temperature;
a tubular support body that supports the cryogenic liquid tank on the vacuum container; and
a heat bridge that connects the tubular support body to the neck tube at an axial position of the axial intermediate portion of the second cylinder.

2. The recondensing device according to claim 1,
wherein the intermediate cooling temperature is in a temperature range of 7 K or more and 20 K or less.

3. The recondensing device according to claim 1,
wherein the axial position at which the heat bridge is connected to the neck tube is selected from a range of ¼ to ¾ at a normalized axial position on the second cylinder.

4. The recondensing device according to claim 1,
wherein the heat bridge is formed of a material having higher thermal conductivity than at least one of the neck tube and the tubular support body.

5. The recondensing device according to claim 4,
wherein the at least one of the neck tube and the tubular support body is formed of a thermal insulation material.

6. The recondensing device according to claim 1,
wherein the tubular support body is configured such that cryogenic liquid vaporized from the cryogenic liquid tank does not flow into the tubular support body.

7. The recondensing device according to claim 1,
wherein the vacuum container is provided with a radiation shield that connects the tubular support body to the neck tube at an axial height of the first cooling stage.
